(19) United States
(12) Patent Application Publication
(10) Pub. No.: US 2020/0013028 A1
(43) Pub. Date: Jan. 9, 2020

(54) PEER-TO-PEER MONEY TRANSFERS

(71) Applicant: American Express Travel Related Services Company, Inc., New York, NY (US)

(72) Inventors: Nicole Black, Boca Raton, FL (US); Sumit Dhama, Plantation, FL (US); Nishant Mittal, Plantation, FL (US); Mohil Soni, Plantation, FL (US)

(73) Assignee: American Express Travel Related Services Company, Inc., New York, NY (US)

(21) Appl. No.: 16/029,966

(22) Filed: Jul. 9, 2018

(51) Int. Cl. G06Q 20/10; G06Q 20/22; G06Q 20/38

(52) U.S. Cl. CPC G06Q 20/10; G06Q 20/388; G06Q 20/223

(57) ABSTRACT

Systems and methods for peer-to-peer money transfers are disclosed. The system may allow senders to transmit money transfers to receivers. The system may receive a money transfer request from the sender comprising the designated receiver, a money transfer amount, and a sender transaction account. The system may deduct the money transfer amount from the sender transaction account. The system may generate a receiver transaction account associated with the designated receiver, wherein the receiver transaction account comprises the money transfer amount. The system may provide the receiver access to the receiver transaction account using different channels, including by providing a digital transaction instrument or a physical transaction instrument.

### FIELD

The disclosure generally relates to financial transactions, and more specifically, to a peer-to-peer money transfer system.

### BACKGROUND

Money transfer products allow users (e.g., senders) to electronically transfer money to a second user (e.g., receivers). Typical money transfer products are limited to transfers between users using the same transfer platform to send and receive the money, and/or between users each having a checking or savings account. For example, a sender may transfer money from a sender checking or savings account to a receiver checking or savings account. As a further example, the sender and the receiver may register and use a common platform to complete money transfers, such as a money transfer platform offered by PAYPAL®, VENMO®, or the like.

### SUMMARY

Systems, methods, and articles of manufacture (collectively, the “system”) for peer-to-peer money transfers are disclosed. The system may receive a money transfer request comprising a receiver, a money transfer amount, and a sender transaction account. The system may deduct the money transfer amount from the sender transaction account. The system may generate a receiver transaction account associated with the receiver, wherein the receiver transaction account comprises the money transfer amount. The system may provide the receiver access to the receiver transaction account. The receiver transaction account may be provided to the receiver as a digital transaction instrument or a physical transaction instrument.

In various embodiments, the system may authorize the money transfer request by validating that the sender transaction account is capable of transferring the money transfer amount. The system may transmit an authentication challenge to a receiver device associated with the receiver. The system may validate an authentication response by comparing the authentication response to the authentication challenge, wherein in response to validating the authentication response the payment network is configured to generate the receiver transaction account.

In various embodiments, the system may transmit a receiver data request to the receiver device associated with the receiver. The receiver data request may comprise data prompting the receiver to input at least one of a receiver name, a receiver email address, a receiver phone number, a receiver social security number (SSN), or a driver's license number. The system may receive a receiver data response based on the receiver data request. The system may authenticate the receiver data response by validating the receiver data response using at least one of an internal data source or an external data source. The money transfer request may also comprise at least one of a transfer channel, a personalized message, or a transfer date. The receiver transaction account may be provided to the receiver via the transfer channel.

The foregoing features and elements may be combined in various combinations without exclusivity, unless expressly indicated herein otherwise. These features and elements as well as the operation of the disclosed embodiments will become more apparent in light of the following description and accompanying drawings.

### BRIEF DESCRIPTION OF THE DRAWINGS

The subject matter of the present disclosure is particularly pointed out and distinctly claimed in the concluding portion of the specification. A more complete understanding of the present disclosure, however, may be obtained by referring to the detailed description and claims when considered in connection with the drawing figures, wherein like numerals denote like elements.

FIG. 1 is a block diagram illustrating various system components of a system for peer-to-peer money transfers, in accordance with various embodiments;

FIG. 2 is a block diagram illustrating various system components of an exemplary payment network for a system for peer-to-peer money transfers, in accordance with various embodiments; and

FIG. 3 illustrates a process flow for a method of peer-to-peer money transfers, in accordance with various embodiments.

### DETAILED DESCRIPTION

The detailed description of exemplary embodiments herein makes reference to the accompanying drawings, which show various embodiments by way of illustration. While these various embodiments are described in sufficient detail to enable those skilled in the art to practice the disclosure, it should be understood that other embodiments may be realized and that logical and mechanical changes may be made without departing from the spirit and scope of the disclosure. Thus, the detailed description herein is presented for purposes of illustration only and not of limitation. For example, the steps recited in any of the method or process descriptions may be executed in any order and are not limited to the order presented. Moreover, any of the functions or steps may be outsourced to or performed by one or more third parties. Furthermore, any reference to singular includes plural embodiments, and any reference to more than one component may include a singular embodiment.

In various embodiments, systems, methods, and articles of manufacture (collectively, the “system”) for peer-to-peer money transfers are disclosed. The system enables a transaction account holder (e.g., a sender) to transfer money to a user (e.g., a receiver). The transaction account holder may transfer money from any type of transaction account, including, for example, credit, checking, savings, or the like. The receiver may not need to utilize the same transfer platform as the sender (e.g., in contrast to typical money transfer products such as VENMO®, PAYPAL®, etc.) or need a transaction account to receive and store the money transfer (e.g., in contrast to typical money transfer products such as ZELLE® provided by EARLY WARNING SERVICES®, VENMO®, PAYPAL®, etc.). The receiver may receive the money transfer using a digital form (e.g., a digital token, a digital wallet, etc.), or via a physical transaction instrument.

This system improves the functioning of the computer and the payment network.

For example, by transmitting, storing, and accessing data using the processes described herein, the security of the data is improved, which decreases the risk of the computer or network from being compromised. As an example, by providing additional steps of authenticating the receiver before transmitting the money transfer, the security of the money transfer is improved, decreasing the risk of money being transferred to an incorrect party, or of a third party intercepting the money transfer. In various embodiments, by providing direct integration to existing payment networks, the system eliminates the need to add additional infrastructure (e.g., computing resources (CPU/Memory), storage, interfaces etc.) on payment platform. The system further enhances the payment network by proving a new peer-to-peer payment method option using collateral, in contrast to traditional issuer/acquirer intermediaries typically used (e.g., in contrast to typical money transfer platforms, the present system does not require an intermediary issuer system, or that the receiver establish a bank account).

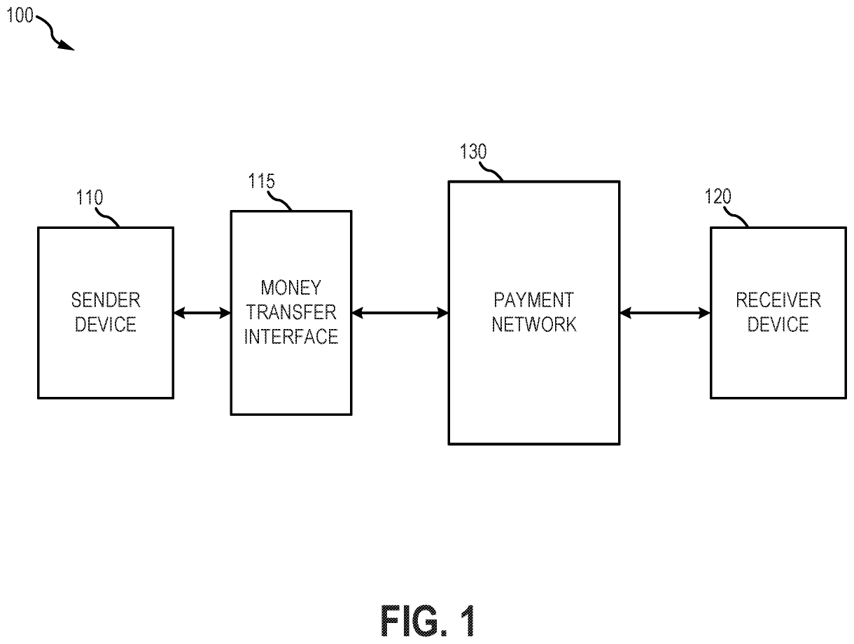

In various embodiments, and with reference to FIG. 1, a system 100 for peer-to-peer money transfers is disclosed. System 100 may comprise one or more of a sender device 110, a receiver device 120, and/or a payment network 130. System 100 may also contemplate uses in association with web services, utility computing, pervasive and individualized computing, security and identity solutions, autonomic computing, cloud computing, commodity computing, mobility and wireless solutions, open source, biometrics, grid computing and/or mesh computing.

In various embodiments, sender device 110 may be configured to initiate money transfers with payment network 130, via a money transfer interface 115, as discussed further herein. For example, a transaction account user, holder, beneficiary, or the like (collectively, the “sender”) may desire to transfer a defined amount of money to a second user (e.g., the “receiver”). As discussed further herein, the sender may interact with money transfer interface 115, via sender device 110, to input one or more money transfer properties and initiate the money transfer to the receiver. Sender device 110 may comprise any suitable hardware, software, and/or database components capable of sending, receiving, and storing data. For example, sender device 110 may comprise a personal computer, personal digital assistant, cellular phone, smartphone (e.g., IPHONE®, BLACKBERRY®, and/or the like), Internet of Things (IoT) device, kiosk, and/or the like. Sender device 110 may comprise an operating system, such as, for example, a WINDOWS® mobile operating system, an ANDROID® operating system, APPLE® IOS®, a BLACKBERRY® operating system, a Linux operating system, and the like. Sender device 110 may comprise software components installed on sender device 110 and configured to allow the sender, via sender device 110, access to money transfer interface 115. For example, sender device 110 may comprise a web browser (e.g., MICROSOFT INTERNET EXPLORER®, GOOGLE CHROME®, etc.), an application, a micro-app or mobile application, or the like, configured to allow the sender to access and interact with money transfer interface 115.

Sender device 110 may be in electronic and/or operative communication with money transfer interface 115. Money transfer interface 115 may comprise software, a mobile application, a web interface, or the like accessible from sender device 110. For example, money transfer interface 115 may include a graphical user interface (“GUI”), software modules, logic engines, various databases, interfaces to systems and tools, and/or computer networks. Money transfer interface 115 may allow the sender, via sender device 110, to initiate one or more money transfers and input various money transfer properties. Money transfer interface 115 may also enable the sender to access and view various data associated to one or more transaction accounts. For example, the sender may access money transfer interface 115 by inputting user credentials (e.g., a username, password, biometric input, etc.), and may view data regarding the sender's transaction accounts, including, for example, account balances, account transactions, or the like. In various embodiments, money transfer interface 115 may be in electronic and/or operative communication with payment network 130. In various embodiments, money transfer interface 115 may be hosted on payment network 130 and accessible via sender device 110.

In various embodiments, money transfer interface 115 may be integrated into, or be in electronic communication with, one or more social media platforms (e.g., FACEBOOK®, INSTAGRAM®, LINKEDIN®, PINTEREST®, QZONE®, SNAPCHAT®, TWITTER®, VKONTAKTE (VK), etc.). For example, the sender may input one or more social media account identifiers (e.g., username and password) into money transfer interface 115 to enable access and communication between money transfer interface 115 and the social media platform. In that respect, and as discussed further herein, the sender may select the receiver from users that the sender is associated with on the enabled social media platform.

In various embodiments, receiver device 120 may be configured to receive money transfers from payment network 130, as discussed further herein. For example, in response to the sender initiating a money transfer, receiver device 120 may receive data associated with the money transfer to enable the receiver to receive the money transfer. As discussed further herein, the receiver may also input into receiver device 120 one or more authentication responses in response to payment network 130 prompting the receiver with an authentication challenge. Receiver device 120 may comprise any suitable hardware, software, and/or database components capable of sending, receiving, and storing data. For example, receiver device 120 may comprise a personal computer, personal digital assistant, cellular phone, smartphone (e.g., IPHONE®, BLACKBERRY®, and/or the like), Internet of Things (IoT) device, kiosk, and/or the like. Receiver device 120 may comprise an operating system, such as, for example, a WINDOWS® mobile operating system, an ANDROID® operating system, APPLE® IOS®, a BLACKBERRY® operating system, a LINUX® operating system, and the like. Receiver device 120 may comprise a web browser (e.g., MICROSOFT INTERNET EXPLORER®, GOOGLE CHROME®, etc.), an email interface, text capabilities (e.g., SMS, MMS, etc.), or the like configured to allow the receiver to receive data regarding the money transfer from payment network 130.

In various embodiments, sender device 110, via money transfer interface 115, and receiver device 120 may be configured to communicate with payment network 130 using a network. As used herein, the term “network” may include any cloud, cloud computing system or electronic communications system or method which incorporates hardware and/or software components. Communication among the parties may be accomplished through any suitable communication channels, such as, for example, a telephone network, an extranet, an intranet, Internet, point of interaction device (point of sale device, personal digital assistant (e.g., IPHONE®, BLACKBERRY®), cellular phone, kiosk, etc.), online communications, satellite communications, off-line communications, wireless communications, transponder communications, local area network (LAN), wide area network (WAN), virtual private network (VPN), networked or linked devices, keyboard, mouse and/or any suitable communication or data input modality. Moreover, although the system is frequently described herein as being implemented with TCP/IP communications protocols, the system may also be implemented using IPX, APPLE® talk, IP-6, NetBIOS®, OSI, any tunneling protocol (e.g. IPsec, SSH, etc.), or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein.

The various system components may be independently, separately or collectively suitably coupled to the network via data links which includes, for example, a connection to an Internet Service Provider (ISP) over the local loop as is typically used in connection with standard modem communication, cable modem, DISH NETWORKS®, ISDN, Digital Subscriber Line (DSL), or various wireless communication methods. It is noted that the network may be implemented as other types of networks, such as an interactive television (ITV) network. Moreover, the system contemplates the use, sale or distribution of any goods, services or information over any network having similar functionality described herein.

“Cloud” or “Cloud computing” includes a model for enabling convenient, on-demand network access to a shared pool of configurable computing resources (e.g., networks, servers, storage, applications, and services) that can be rapidly provisioned and released with minimal management effort or service provider interaction. Cloud computing may include location-independent computing, whereby shared servers provide resources, software, and data to computers and other devices on demand. For more information regarding cloud computing, see the NIST's (National Institute of Standards and Technology) definition of cloud computing.

In various embodiments, payment network 130 may be configured to receive one or more money transfer requests from sender device 110, authorize the money transfer requests, authenticate the receiver associated with the money transfer request, generate a money transfer based on the money transfer request, and transmit data regarding the money transfer to receiver device 120, as discussed further herein. Payment network 130 may comprise any suitable combination of hardware, software, and/or database components. For example, payment network 130 may comprise one or more network environments, servers, computer-based systems, processors, databases, and/or the like. Payment network 130 may comprise at least one computing device in the form of a computer or processor, or a set of computers/processors, although other types of computing units or systems may be used, such as, for example, a server, web server, pooled servers, or the like. Payment network 130 may also include one or more data centers, cloud storages, or the like, and may include software, such as APIs, configured to perform various operations discussed herein. In various embodiments, payment network 130 may include one or more processors and/or one or more tangible, non-transitory memories and be capable of implementing logic. The processor may be configured to implement various logical operations in response to execution of instructions, for example, instructions stored on a non-transitory, tangible, computer-readable medium, as discussed further herein.

In various embodiments, payment network 130 may comprise or interact with a traditional payment network or transaction network to facilitate purchases and payments, authorize transaction, settle transactions, and the like. For example, payment network 130 may represent existing proprietary networks that presently accommodate transactions for credit cards, debit cards, and/or other types of transaction accounts or transaction instruments. Payment network 130 may be a closed network that is secure from eavesdroppers. In various embodiments, payment network 130 may comprise an exemplary transaction network such as AMERICAN EXPRESS®, VISANET®, MASTERCARD®, DISCOVER®, INTERAC®, Cartes Bancaires, JCB®, private networks (e.g., department store networks), and/or any other payment network, transaction network, or the like. Payment network 130 may include systems and databases related to financial and/or transactional systems and processes, such as, for example, one or more authorization engines, authentication engines and databases, settlement engines and databases, accounts receivable systems and databases, accounts payable systems and databases, and/or the like. In various embodiments, payment network may also comprise a transaction account issuer's Credit Authorization System (“CAS”) capable of authorizing transactions, as discussed further herein. Payment network 130 may be configured to authorize and settle transactions, and maintain transaction account member databases, accounts receivable databases, accounts payable databases, or the like.

Although the present disclosure makes reference to payment network 130, it should be understood that principles of the present disclosure may be applied to a peer-to-peer money transfer system having any suitable number of payment networks. For example, system 100 may comprise one or more payment networks 130 each corresponding to or associated with a different issuer system or network.

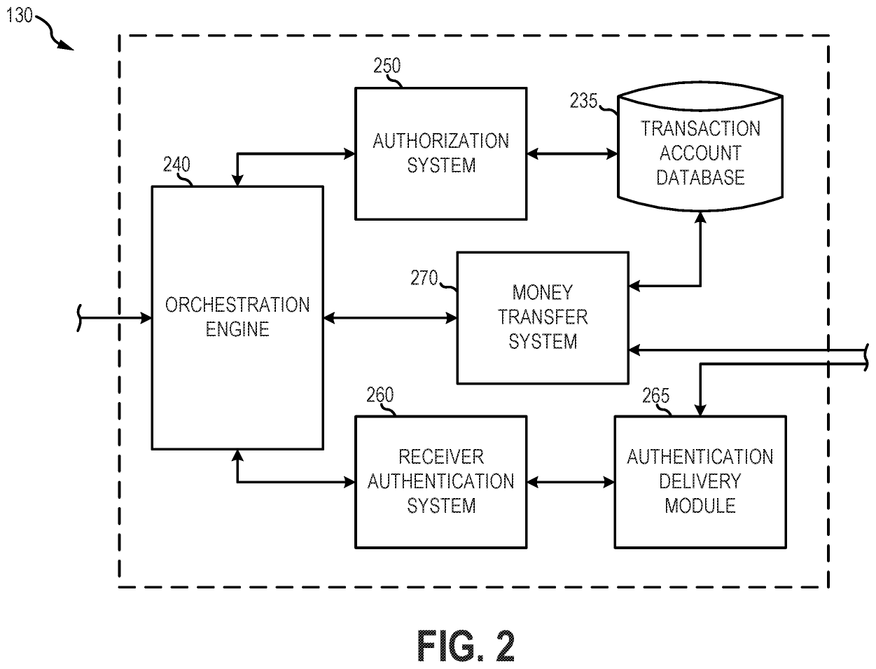

In various embodiments, and with reference to FIG. 2, an exemplary payment network 130 is depicted. Payment network 130 may comprise one or more of an orchestration engine 240, an authorization system 250, a transaction account database 235, a receiver authentication system 260, an authentication delivery module 265, and/or a money transfer system 270. Orchestration engine 240, authorization system 250, transaction account database 235, receiver authentication system 260, authentication delivery module 265, and/or money transfer system 270 may be in direct logical and/or electronic communication with each other via a bus, network, and/or through any other suitable means. In various embodiments, each engine, system, database, module, or component in payment network 130 may also be individually and directly connected, as discussed further herein.

In various embodiments, orchestration engine 240 may be configured as a central access point to access various systems, engines, and components of payment network 130. Orchestration engine 240 may be in electronic and/or logical communication with authorization system 250, receiver authentication system 260, and/or money transfer system 270. Orchestration engine 240 may comprise one or more software, hardware, and/or database components. For example, orchestration engine 240 may comprise a sub-network, computer-based system, software component, and/or the like. Orchestration engine 240 may be configured to receive a money transfer request from sender device 110, via money transfer interface 115. As discussed further herein, orchestration engine 240 may transmit data and instruct authorization system 250, receiver authentication system 260, and/or money transfer system 270 to perform operations to authorize and complete the money transfer.

In various embodiments, authorization system 250 may be configured to authorize money transfer requests initiated by the sender. Authorization system 250 may be in electronic and/or logical communication with orchestration engine 240 and/or transaction account database 235. Authorization system 250 may comprise one or more software, hardware, and/or database components. Authorization system 250 may be configured to receive transfer authorization requests from orchestration engine 240, authorize the transfer authorization request, and transmit back a transfer authorization response, as discussed further herein. For example, authorization system 250 may authorize money transfers by querying transaction account database 235 to ensure that the sender transaction account has the funds necessary to complete the transfer. Transaction account database 235 may comprise any suitable database or data structure and may be configured to store and maintain transaction account data, such as, for example, a transaction account number, a transaction account balance, and the like. For example, transaction account database 235 may be configured to store and maintain sender transaction account data and receiver transaction account data. The receiver transaction account data may be associated with the sender transaction account data using metadata, tags, or the like (e.g., the sender transaction account may be associated with all of the receiver transaction accounts created during the money transfer process, as discussed further herein).

In various embodiments, receiver authentication system 260 may be configured to authenticate the receiver specified to receive the money transfer by the sender. Receiver authentication system 260 may be in electronic and/or logical communication with orchestration engine 240 and/or authentication delivery module 265. Receiver authentication system 260 may comprise one or more software, hardware, and/or database components. Receiver authentication system 260 may be configured to receive a receiver authentication request from orchestration engine 240, generate an authentication challenge based on the receiver authentication request, and instruct authentication delivery module 265 to transmit the authentication challenge to receiver device 120, as discussed further herein. Authentication delivery module 265 may comprise one or more software, hardware, and/or database components. Authentication delivery module 265 may be configured to communicate with receiver device 120 using the transfer channel defined by the sender in the money transfer request. For example, the transfer channel may comprise email, SMS (short message service), MMS (multimedia messaging service), or any other suitable communication channel. Authentication delivery module 265 may be configured to transmit the authentication challenge to receiver device 120 and receive back an authentication challenge response, as discussed further herein. In response to receiving the authentication challenge response, via authentication delivery module 265, receiver authentication system 260 may be configured to validate the response to authenticate the receiver, as discussed further herein.

In various embodiments, money transfer system 270 may be configured to communicate with receiver device 120 to complete the money transfer. Money transfer system 270 may be in electronic and/or logical communication with orchestration engine 240 and/or transaction account database 235. Money transfer system 270 may comprise one or more software, hardware, and/or database components. As discussed further herein, in response to receiving the money transfer request, via orchestration engine 240, money transfer system 270 may perform various operations to complete the money transfer. For example, money transfer system 270 may prompt receiver device 120 to input additional received identifying data, such as, for example, a receiver name, a receiver phone number, a receiver mail address, a social security number (SSN), or the like. Money transfer system 270 may also generate a receiver transaction account based on the money transfer request, and store the receiver transaction account in transaction account database 235.

In that regard, money transfer system 270 may generate the receiver transaction account without needing the receiver to register for payment network 130, and without needing to authenticate the user for registration of a transaction account. For more information on systems and methods for completing transactions without needing a user to fully register for a transaction account or service, see U.S. application Ser. No. 13/690,878 titled SYSTEMS AND METHODS FOR CONDUCTING A QUICK TRANSACTION and filed on Nov. 30, 2012, the contents of which are incorporated by reference in its entirety.

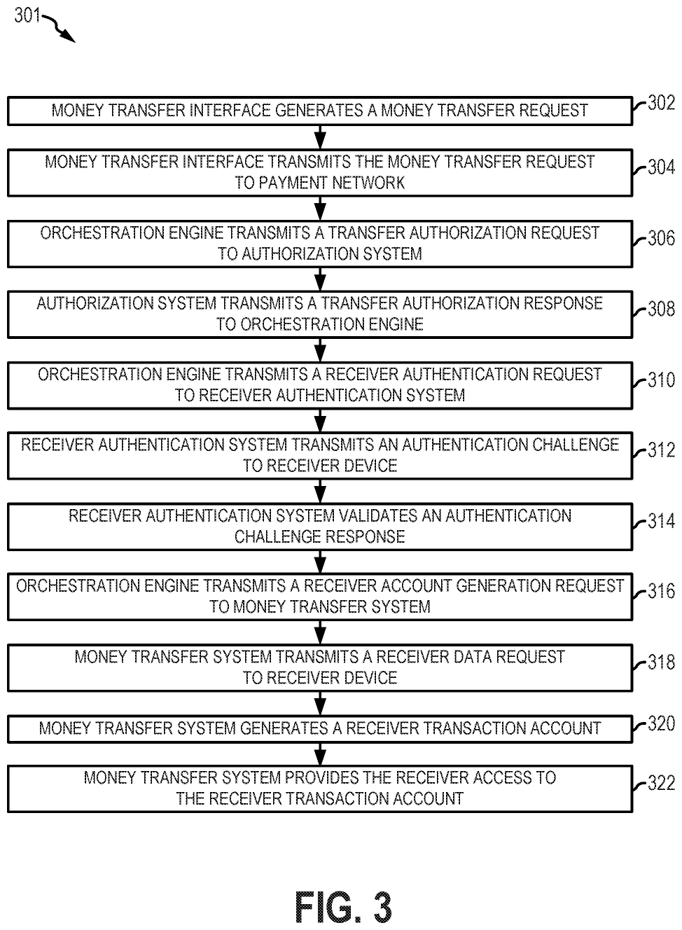

Referring now to FIG. 3 the process flow depicted is merely an embodiment and is not intended to limit the scope of the disclosure. For example, the steps recited in any of the method or process descriptions may be executed in any order and are not limited to the order presented. It will be appreciated that the following description makes appropriate references not only to the steps and elements depicted in FIG. 3, but also to the various system components as described above with reference to FIGS. 1 and 2.

In various embodiments, and with specific reference to FIG. 3, a method 301 for peer-to-peer money transfers is disclosed. Method 301 may enable a sender to transfer money from the sender's transaction account (e.g., credit account, checking account, savings account, etc.) to a receiver. Method 301 may enable the receiver to receive the money transfer without needing the receiver to have a preexisting transaction account (e.g., checking account, savings account, etc.), and without needing the receiver device to have special software or hardware to participate, such as common transfer platform (e.g., in contrast to the common transfer platforms offered by PAYPAL®, ZELLE®, etc.).

In various embodiments, the sender may interact with money transfer interface 115, via sender device 110, to initiate a peer-to-peer money transfer. For example, the sender may access money transfer interface 115 by inputting sender identifying data, such as a username, password, biometric input, or the like. Accessing money transfer interface 115 may enable the sender to access and view data regarding associated transaction accounts, and/or may provide an interface for the sender to initiate a money transfer. The sender may initiate a money transfer by selecting a money transfer amount, a designated receiver, and a sender transaction account. The sender transaction account may be selected from one or more associated transaction accounts that the sender desires to transfer the money from. The designated receiver may be selected or input by the sender, and may include data such as, for example, a receiver name, a receiver phone number, a receiver email address, a receiver mailing address, or the like. In various embodiments, money transfer interface 115 may integrate with or be in communication with one or more social media accounts, email accounts, directories, contact lists, or the like associated with the sender. The sender may interact with money transfer interface 115 to access and select the receiver from a list provided by the sender, obtained from a database or populated from one or more associated social media accounts, email accounts, directories, or contact lists. For example, money transfer interface 115 may interact with one or more social media platforms via an application programming interface (API) provided each social media platform. In that regard, different social media platforms may expose different and unique APIs for money transfer interface 115 to interact with.

In various embodiments, the sender may also select one or more money transfer properties, such as, for example, a transfer channel, a personalized message, a transfer date, a transfer time of day, and/or the like. The transfer channel may define the communications channel the money transfer is to be sent using, such as, for example, email, SMS, MMS, or the like. The transfer data may comprise the current date or a future date, and may be input together with a transfer time of day to control when the money transfer is to take place.

In response to the sender initiating a money transfer, money transfer interface 115 generates a money transfer request (step 302). The money transfer request may comprise any suitable data regarding the money transfer, such as, for example, the designated receiver, a money transfer amount, the sender transaction account, the transfer channel, the personalized message, the transfer date, the transfer time of day, and/or the like. Money transfer interface 115 transmits the money transfer request to payment network 130 (step 304).

In various embodiments, in response to receiving the money transfer request, orchestration engine 240 may be configured to facilitate authorization of the money transfer request to ensure that the sender is capable of transferring the money to the receiver. Orchestration engine 240 transmits a transfer authorization request to authorization system 250 (step 306). The transfer authorization request may comprise the sender transaction account and the money transfer amount. Authorization system 250 may query transaction account database 235 to retrieve data corresponding to the sender transaction account (e.g., based on a sender transaction account ID, a sender username, etc.). Authorization system 250 may compare the account balance of the sender transaction account to the money transfer amount to determine whether the sender transaction account comprises the funds necessary to complete the money transfer request (e.g., based on an available credit limit, a savings account or checking account balance, etc.). In various embodiments, authorization system 250 may initiate a hold on the sender transaction account, based on the money transfer amount, to limit use of the needed funds until the money transfer is completed. Authorization system 250 transmits a transfer authorization response to orchestration engine 240 (step 308). The transfer authorization response may comprise data indicating whether the sender is capable of transferring the money to the receiver (e.g., “pass,” “fail,” “insufficient funds,” etc.). In response to the sender having insufficient funds, orchestration engine 240 may display to the user the available account balance and request the sender to input a lower transfer amount.

In various embodiments, in response to receiving a transfer authorization response indicating that the sender is capable of completing the money transfer request, orchestration engine 240 transmits a receiver authentication request to receiver authentication system 260 (step 310). The receiver authentication request may comprise the receiver data and the transfer channel. In response to receiving the receiver authentication request, receiver authentication system 260 may generate an authentication challenge. Receiver authentication system 260 transmits the authentication challenge to receiver device 120 (step 312), via authentication delivery module 265. The authentication challenge may comprise a multi-factor authentication challenge. For example, if the receiver had previously registered with payment network 130 using a biometric input, username and password, or the like, the authentication challenge may comprise data prompting the receiver to input the biometric input together with the user's password (e.g., a 2-factor authentication), via receiver device 120. As a further example, two-factor authentication may comprise sending an authentication number (e.g., a PIN, a code, a 6-digit number, etc.) via the specified transfer channel, and prompting the receiver to input the authentication number into receiver device 120 before proceeding.

In response to receiving the authentication challenge response via authentication delivery module 265, receiver authentication system 260 validates the authentication challenge response (step 314). For example, in response to the authentication challenge response comprising a biometric input or the like, receiver authentication system 260 may compare the biometric input against stored receiver biometric data to validate the authentication challenge response. As a further example, in response to the authentication challenge response comprising two-factor authentication, a one-time password, or the like, receiver authentication system 260 may compare the authentication challenge response to the authentication number transmitted to the receiver via the specified transfer channel. In response to validating the authentication challenge response, receiver authentication system 260 may notify orchestration engine 240 that the money transfer may proceed.

In various embodiments, orchestration engine 240 transmits the money transfer request to money transfer system 270 (step 316). In response to receiving the money transfer request, money transfer system 270 may generate a receiver data request. The receiver data request may comprise data prompting the receiver to input a receiver name (e.g., first name, last name, middle name or initial, etc.), a receiver email address, a receiver phone number, a receiver social security number (SSN), a driver's license number, or the like. Money transfer system 270 transmits the receiver data request to receiver device 120 (step 318). Money transfer system 270 may transmit the receiver data request via the transfer channel specified in the money transfer request (e.g., via email, SMS, etc.). The receiver, via receiver device 120, may input data corresponding to the receiver data request to generate a receiver data response. In various embodiments wherein the receiver has a pre-established relationship with payment network 130 (e.g., the receiver is a transaction account holder) or has received a money transfer from system 100 before, the receiver data request may be pre-populated with the receiver data such that the receiver may just acknowledge that the receiver data is correct or update any fields as needed. Receiver device 120 may transmit the receiver data response to money transfer system 270.

In various embodiments, money transfer system 270 may be configured to perform a (second) authentication of the receiver by analyzing the receiver data response. For example, money transfer system 270 may validate the receiver data response using internal and/or external data sources. For example, money transfer system 270 may validate the receiver data response by querying LEXIS NEXIS®, the United States Post Office, utility providers, password validation services, and/or any other consumer reporting agency, vendor, database, or system that provides information regarding consumers and businesses.

In various embodiments, money transfer system 270 generates a receiver transaction account (step 320), and stores the receiver transaction account in transaction account database 235. The receiver transaction account may be associated with the receiver data (e.g., receiver name, etc.). Money transfer system 270 may debit the money transfer amount from the sender transaction account (e.g., in a checking or savings account) or charge the money transfer amount to the sender transaction account (e.g., in a credit account), and credit the money transfer amount to the receiver transaction account. In that regard, the receiver transaction account may function as a typical transaction account comprising a limit of the money transfer amount. Money transfer system 270 provides the receiver access to the receiver transaction account (step 322). For example, access to the receiver transaction account may be provided in a digital form or a physical form. In various embodiments, the receiver may also elect to split the money transfer amount across different payment forms.

In various embodiments, access to the receiver transaction account may be provided in a digital form, such as, for example as a digital token or by storing receiver transaction account data in a digital wallet (e.g., APPLE PAY®, SAMSUNG PAY®, etc.). For example, a digital token may be generated using any suitable method, and may be transmitted to receiver device 120 and stored digitally via a digital wallet or the like. As a further example, receiver transaction account data (e.g., a receiver transaction account number) may be transmitted to receiver device 120, and the digital data may be stored as a temporary card in a digital wallet on receiver device 120. In various embodiments, access to the receiver transaction account may be provided in a physical form, such as, for example, by issuing a physical transaction instrument. The physical transaction instrument may be issued using any suitable method, and may be mailed to the receiver at the receiver mailing address. The physical transaction instrument may function as a typical credit card, debit card, or the like, and may be associated with the receiver transaction account to complete transactions.

In various embodiments, in response to the receiver using the receiver transaction account to make a purchase, payment network 130 may notify sender device 110 that the receiver transaction account has been used. In various embodiments, payment network 130 may also be configured to transmit transaction account offers or the like to the receiver, via receiver device 120, based on the receiver's use of the receiver transaction account, the receiver data, or the like. In various embodiments, payment network 130 may also be configured to track and maintain data regarding purchases completed using the receiver transaction account. In that regard, payment network 130 may perform data analysis on the purchase data.

Systems, methods and computer program products are provided. In the detailed description herein, references to “various embodiments,” “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

As used herein, “satisfy,” “meet,” “match,” “associated with” or similar phrases may include an identical match, a partial match, meeting certain criteria, matching a subset of data, a correlation, satisfying certain criteria, a correspondence, an association, an algorithmic relationship and/or the like. Similarly, as used herein, “authenticate” or similar terms may include an exact authentication, a partial authentication, authenticating a subset of data, a correspondence, satisfying certain criteria, an association, an algorithmic relationship and/or the like.

Terms and phrases similar to “associate” and/or “associating” may include tagging, flagging, correlating, using a look-up table or any other method or system for indicating or creating a relationship between elements such as, for example, (i) a transaction account and (ii) an item (e.g., offer, reward points, discount) and/or digital channel. Moreover, the associating may occur at any point, in response to any suitable action, event, or period of time. The associating may occur at pre-determined intervals, periodic, randomly, once, more than once, or in response to a suitable request or action. Any of the information may be distributed and/or accessed via a software enabled link, wherein the link may be sent via an email, text, post, social network input and/or any other method known in the art.

Phrases and terms similar to “account,” “account number,” “account code” or “transaction account” as used herein, including the sender transaction account and/or the receiver transaction account, may include any device, code (e.g., one or more of an authorization/access code, personal identification number (“PIN”), Internet code, other identification code, and/or the like), number, letter, symbol, digital certificate, smart chip, digital signal, analog signal, biometric or other identifier/indicia suitably configured to allow the consumer to access, interact with or communicate with the system. The account number may optionally be located on or associated with a rewards account, charge account, credit account, debit account, prepaid account, telephone card, embossed card, smart card, magnetic stripe card, bar code card, transponder, radio frequency card or an associated account.

The account number may be distributed and stored in any form of plastic, electronic, magnetic, radio frequency, wireless, audio and/or optical device capable of transmitting or downloading data from itself to a second device. A transaction account number may be, for example, a sixteen-digit account number, although each credit provider has its own numbering system, such as the fifteen-digit numbering system used by AMERICAN EXPRESS®. Each company's account numbers comply with that company's standardized format such that the company using a fifteen-digit format will generally use three-spaced sets of numbers, as represented by the number “0000 000000 00000.” The first five to seven digits are reserved for processing purposes and identify the issuing bank, account type, etc. In this example, the last (fifteenth) digit is used as a sum check for the fifteen digit number. The intermediary eight-to-eleven digits are used to uniquely identify the consumer (e.g., the sender or the receiver).

In various embodiments, an account number may identify a consumer. In addition, in various embodiments, a consumer may be identified by a variety of identifiers, including, for example, an email address, a telephone number, a cookie id, a radio frequency identifier (RFID), a biometric, and the like.

Phrases and terms similar to “financial institution,” “transaction account issuer,” “issuer system,” or the like may include any entity that offers transaction account services. Although often referred to as a “financial institution,” the financial institution may represent any type of bank, lender, or other type of account issuing institution, such as credit card companies, card sponsoring companies, or third party issuers under contract with financial institutions. It is further noted that other participants may be involved in some phases of the transaction, such as an intermediary settlement institution.

The terms “payment vehicle,” “transaction account,” “financial transaction instrument,” “transaction instrument” and/or the plural form of these terms may be used interchangeably throughout to refer to a financial instrument. Phrases and terms similar to “transaction account” may include any account that may be used to facilitate a financial transaction.

In various embodiments, sender device 110 and/or receiver device 120 may integrate with one or more smart digital assistant technologies. For example, exemplary smart digital assistant technologies may include the ALEXA system developed by AMAZON®, GOOGLE HOME®, APPLE® HOMEPOD®, and/or the similar digital assistant technologies. AMAZON ALEXA, GOOGLE HOME®, and APPLE® HOMEPOD®, may all provide cloud-based voice services that can assist with tasks, entertainment, general information, and more. All AMAZON® ALEXA devices, such as the AMAZON ECHO®, AMAZON ECHO DOT®, AMAZON TAP®, and AMAZON FIRE® TV, have access to the ALEXA system. The ALEXA, GOOGLE HOME®, and APPLE® HOMEPOD® systems may receive voice commands via its voice activation technology, and activate other functions, control smart devices and/or gather information. For example, music, emails, texts, calling, questions answered, home improvement information, smart home communication/activation, games, shopping, making to-do lists, setting alarms, streaming podcasts, playing audiobooks, and providing weather, traffic, and other real time information, such as news. The ALEXA, GOOGLE HOME®, and APPLE® HOMEPOD® systems may allow the user to access information about eligible accounts linked to an online account across all ALEXA-enabled devices.

Any communication, transmission and/or channel discussed herein may include any system or method for delivering content (e.g. data, information, metadata, etc.), and/or the content itself. The content may be presented in any form or medium, and in various embodiments, the content may be delivered electronically and/or capable of being presented electronically. For example, a channel may comprise a website or device (e.g., Facebook, YOUTUBE®, APPLE® TV®, PANDORA®, XBOX®, SONY® PLAYSTATION®), a uniform resource locator (“URL”), a document (e.g., a MICROSOFT® Word® document, a MICROSOFT® Excel® document, an ADOBE®.pdf document, etc.), an “ebook,” an “emagazine,” an application or microapplication (as described herein), an SMS or other type of text message, an email, a FACEBOOK® message, a TWITTER® tweet, MMS and/or other type of communication technology. In various embodiments, a channel may be hosted or provided by a data partner. In various embodiments, the distribution channel may comprise at least one of a merchant website, a social media website, affiliate or partner websites, an external vendor, a mobile device communication, social media network and/or location based service. Distribution channels may include at least one of a merchant website or application; a social media site, application, or platform; affiliate or partner websites and applications; an external vendor, and a mobile device communication. Examples of social media sites, applications, and platforms may include FACEBOOK®, INSTAGRAM®, LINKEDIN®, PINTEREST®, QZONE®, SNAPCHAT®, TWITTER®, VKontakte (VK), and the like. Examples of affiliate or partner websites include AMERICAN EXPRESS®, GROUPON®, LIVINGSOCIAL®, and the like. Moreover, examples of mobile device communications include texting, email, and mobile applications for smartphones.

In various embodiments, the methods described herein are implemented using the various particular machines described herein. The methods described herein may be implemented using the below particular machines, and those hereinafter developed, in any suitable combination, as would be appreciated immediately by one skilled in the art. Further, as is unambiguous from this disclosure, the methods described herein may result in various transformations of certain articles.

The various system components discussed herein may include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. Various databases used herein may include: client data; merchant data; financial institution data; and/or like data useful in the operation of the system. As those skilled in the art will appreciate, user computer may include an operating system (e.g., WINDOWS®, OS2, UNIX®, LINUX®, SOLARIS®, MacOS, etc.) as well as various conventional support software and drivers typically associated with computers.

The present system or any part(s) or function(s) thereof may be implemented using hardware, software or a combination thereof and may be implemented in one or more computer systems or other processing systems. However, the manipulations performed by embodiments were often referred to in terms, such as matching or selecting, which are commonly associated with mental operations performed by a human operator. No such capability of a human operator is necessary, or desirable in most cases, in any of the operations described herein. Rather, the operations may be machine operations or any of the operations may be conducted or enhanced by Artificial Intelligence (AI) or Machine Learning. Useful machines for performing the various embodiments include general purpose digital computers or similar devices.

In fact, and in accordance with various embodiments, the embodiments are directed toward one or more computer systems capable of carrying out the functionality described herein. The computer system includes one or more processors, such as processor. The processor is connected to a communication infrastructure (e.g., a communications bus, cross over bar, or network). Various software embodiments are described in terms of this exemplary computer system. After reading this description, it will become apparent to a person skilled in the relevant art(s) how to implement various embodiments using other computer systems and/or architectures. Computer system can include a display interface that forwards graphics, text, and other data from the communication infrastructure (or from a frame buffer not shown) for display on a display unit.

The computer system also includes a main memory, such as for example random access memory (RAM), and may also include a secondary memory or in-memory (non-spinning) hard drives. The secondary memory may include, for example, a hard disk drive and/or a removable storage drive, representing a floppy disk drive, a magnetic tape drive, an optical disk drive, etc. The removable storage drive reads from and/or writes to a removable storage unit in a well-known manner. Removable storage unit represents a floppy disk, magnetic tape, optical disk, etc. which is read by and written to by removable storage drive. As will be appreciated, the removable storage unit includes a computer usable storage medium having stored therein computer software and/or data.

In various embodiments, secondary memory may include other similar devices for allowing computer programs or other instructions to be loaded into computer system. Such devices may include, for example, a removable storage unit and an interface. Examples of such may include a program cartridge and cartridge interface (such as that found in video game devices), a removable memory chip (such as an erasable programmable read only memory (EPROM), or programmable read only memory (PROM)) and associated socket, and other removable storage units and interfaces, which allow software and data to be transferred from the removable storage unit to computer system.

The computer system may also include a communications interface. Communications interface allows software and data to be transferred between computer system and external devices. Examples of communications interface may include a modem, a network interface (such as an Ethernet card), a communications port, a Personal Computer Memory Card International Association (PCMCIA) slot and card, etc. Software and data files transferred via communications interface are in the form of signals which may be electronic, electromagnetic, optical or other signals capable of being received by communications interface. These signals are provided to communications interface via a communications path (e.g., channel). This channel carries signals and may be implemented using wire, cable, fiber optics, a telephone line, a cellular link, a radio frequency (RF) link, wireless and other communications channels.

The terms “computer program medium” and “computer usable medium” and “computer readable medium” are used to generally refer to media such as removable storage drive and a hard disk installed in hard disk drive. These computer program products provide software to computer system.

Computer programs (also referred to as computer control logic) are stored in main memory and/or secondary memory. Computer programs may also be received via communications interface. Such computer programs, when executed, enable the computer system to perform the features as discussed herein. In particular, the computer programs, when executed, enable the processor to perform the features of various embodiments. Accordingly, such computer programs represent controllers of the computer system.

In various embodiments, software may be stored in a computer program product and loaded into computer system using removable storage drive, hard disk drive or communications interface. The control logic (software), when executed by the processor, causes the processor to perform the functions of various embodiments as described herein. In various embodiments, hardware components such as application specific integrated circuits (ASICs). Implementation of the hardware state machine so as to perform the functions described herein will be apparent to persons skilled in the relevant art(s).

In various embodiments, the server may include application servers (e.g. WEBSPHERE®, WEBLOGIC®, MOSS®, EDB® POSTGRES PLUS ADVANCED SERVER® (PPAS), etc.). In various embodiments, the server may include web servers (e.g. APACHE®, IIS, GWS, SUN JAVA® SYSTEM WEB SERVER, JAVA® Virtual Machine running on LINUX® or WINDOWS®).

A web client includes any device (e.g., personal computer) which communicates via any network, for example such as those discussed herein. Such browser applications comprise Internet browsing software installed within a computing unit or a system to conduct online transactions and/or communications. These computing units or systems may take the form of a computer or set of computers, although other types of computing units or systems may be used, including laptops, notebooks, tablets, hand held computers, personal digital assistants, set-top boxes, workstations, computer-servers, main frame computers, mini-computers, PC servers, pervasive computers, network sets of computers, personal computers, such as IPADS®, IMACS®, and MACBOOKS®, kiosks, terminals, point of sale (PoS) devices and/or terminals, televisions, or any other device capable of receiving data over a network. A web-client may run MICROSOFT® INTERNET EXPLORER®, MOZILLA® FIREFOX®, GOOGLE® CHROME®, APPLE® Safari, or any other of the myriad software packages available for browsing the internet.

As those skilled in the art will appreciate that a web client may or may not be in direct contact with an application server. For example, a web client may access the services of an application server through another server and/or hardware component, which may have a direct or indirect connection to an Internet server. For example, a web client may communicate with an application server via a load balancer. In various embodiments, access is through a network or the Internet through a commercially-available web-browser software package.

As those skilled in the art will appreciate, a web client includes an operating system (e.g., WINDOWS® OS, OS2, UNIX® OS, LINUX® OS, SOLARIS®, MacOS, and/or the like) as well as various conventional support software and drivers typically associated with computers. A web client may include any suitable personal computer, network computer, workstation, personal digital assistant, cellular phone, smart phone, minicomputer, mainframe or the like. A web client can be in a home or business environment with access to a network. In various embodiments, access is through a network or the Internet through a commercially available web-browser software package. A web client may implement security protocols such as Secure Sockets Layer (SSL) and Transport Layer Security (TLS). A web client may implement several application layer protocols including http, https, ftp, and sftp.

In various embodiments, components, modules, and/or engines of system 100 may be implemented as micro-applications or micro-apps. Micro-apps are typically deployed in the context of a mobile operating system, including for example, a WINDOWS® mobile operating system, an ANDROID® operating system, APPLE® IOS®, a BLACKBERRY® operating system and the like. The micro-app may be configured to leverage the resources of the larger operating system and associated hardware via a set of predetermined rules which govern the operations of various operating systems and hardware resources. For example, where a micro-app desires to communicate with a device or network other than the mobile device or mobile operating system, the micro-app may leverage the communication protocol of the operating system and associated device hardware under the predetermined rules of the mobile operating system. Moreover, where the micro-app desires an input from a user, the micro-app may be configured to request a response from the operating system which monitors various hardware components and then communicates a detected input from the hardware to the micro-app.

As used herein an “identifier” may be any suitable identifier that uniquely identifies an item. For example, the identifier may be a globally unique identifier (“GUID”). The GUID may be an identifier created and/or implemented under the universally unique identifier standard. Moreover, the GUID may be stored as 128-bit value that can be displayed as 32 hexadecimal digits. The identifier may also include a major number, and a minor number. The major number and minor number may each be 16 bit integers.

As used herein, “issue a debit,” “debit” or “debiting” refers to either causing the debiting of a stored value or prepaid card-type financial account, or causing the charging of a credit or charge card-type financial account, as applicable.

Any databases discussed herein may include relational, hierarchical, graphical, blockchain, or object-oriented structure and/or any other database configurations. Any database may also include a flat file structure wherein data may be stored in a single file in the form of rows and columns, with no structure for indexing and no structural relationships between records. For example, a flat file structure may include a delimited text file, a CSV (comma-separated values) file, and/or any other suitable flat file structure. Common database products that may be used to implement the databases include DB2 by IBM® (Armonk, N.Y.), various database products available from ORACLE® Corporation (Redwood Shores, Calif.), MICROSOFT ACCESS® or MICROSOFT SQL SERVER® by MICROSOFT® Corporation (Redmond, Wash.), MySQL by MySQL AB (Uppsala, Sweden), MONGODB®, REDIS®, APACHE CASSANDRA®, HBase by APACHE®, MapR-DB, or any other suitable database product. Moreover, the databases may be organized in any suitable manner, for example, as data tables or lookup tables. Each record may be a single file, a series of files, a linked series of data fields or any other data structure.

Any database discussed herein may comprise a distributed ledger maintained by a plurality of computing devices (e.g., nodes) over a peer-to-peer network. Each computing device maintains a copy and/or partial copy of the distributed ledger and communicates with one or more other computing devices in the network to validate and write data to the distributed ledger. The distributed ledger may use features and functionality of blockchain technology, including, for example, consensus based validation, immutability, and cryptographically chained blocks of data. The blockchain may comprise a ledger of interconnected blocks containing data. The blockchain may provide enhanced security because each block may hold individual transactions and the results of any blockchain executables. Each block may link to the previous block and may include a timestamp. Blocks may be linked because each block may include the hash of the prior block in the blockchain. The linked blocks form a chain, with only one successor block allowed to link to one other predecessor block for a single chain. Forks may be possible where divergent chains are established from a previously uniform blockchain, though typically only one of the divergent chains will be maintained as the consensus chain. In various embodiments, the blockchain may implement smart contracts that enforce data workflows in a decentralized manner. The system may also include applications deployed on user devices such as, for example, computers, tablets, smartphones, Internet of Things devices (“IoT” devices), etc. The applications may communicate with the blockchain (e.g., directly or via a blockchain node) to transmit and retrieve data. In various embodiments, a governing organization or consortium may control access to data stored on the blockchain. Registration with the managing organization(s) may enable participation in the blockchain network.

Data transfers performed through the blockchain-based system may propagate to the connected peers within the blockchain network within a duration that may be determined by the block creation time of the specific blockchain technology implemented. For example, on an ETHEREUM®-based network, a new data entry may become available within about 13-20 seconds as of the writing. On a Hyperledger® Fabric 1.0 based platform, the duration is driven by the specific consensus algorithm that is chosen, and may be performed within seconds. In that respect, propagation times in the system may be improved compared to existing systems, and implementation costs and time to market may also be drastically reduced. The system also offers increased security at least partially due to the immutable nature of data that is stored in the blockchain, reducing the probability of tampering with various data inputs and outputs. Moreover, the system may also offer increased security of data by performing cryptographic processes on the data prior to storing the data on the blockchain. Therefore, by transmitting, storing, and accessing data using the system described herein, the security of the data is improved, which decreases the risk of the computer or network from being compromised.

In various embodiments, the blockchain-based system may also reduce database synchronization errors by providing a common data structure, thus at least partially improving the integrity of stored data. The system also offers increased reliability and fault tolerance over traditional databases (e.g., relational databases, distributed databases, etc.) as each node operates with a full copy of the stored data, thus at least partially reducing downtime due to localized network outages and hardware failures. The system may also increase the reliability of data transfers in a network environment having reliable and unreliable peers, as each node broadcasts messages to all connected peers, and, as each block comprises a link to a previous block, a node may quickly detect a missing block and propagate a request for the missing block to the other nodes in the blockchain network. For more information on distributed ledgers implementing features and functionalities of blockchain, see U.S. application Ser. No. 15/266,350 titled SYSTEMS AND METHODS FOR BLOCKCHAIN BASED PAYMENT NETWORKS and filed on Sep. 15, 2016, U.S. application Ser. No. 15/682,180 titled SYSTEMS AND METHODS FOR DATA FILE TRANSFER BALANCING AND CONTROL ON BLOCKCHAIN and filed Aug. 21, 2017, U.S. application Ser. No. 15/728,086 titled SYSTEMS AND METHODS FOR LOYALTY POINT DISTRIBUTION and filed Oct. 9, 2017, U.S. application Ser. No. 15/785,843 titled MESSAGING BALANCING AND CONTROL ON BLOCKCHAIN and filed on Oct. 17, 2017, U.S. application Ser. No. 15/785,870 titled API REQUEST AND RESPONSE BALANCING AND CONTROL ON BLOCKCHAIN and filed on Oct. 17, 2017, U.S. application Ser. No. 15/824,450 titled SINGLE SIGN-ON SOLUTION USING BLOCKCHAIN and filed on Nov. 28, 2017, U.S. application Ser. No. 15/824,513 titled TRANSACTION AUTHORIZATION PROCESS USING BLOCKCHAIN and filed on Nov. 28, 2017, U.S. application Ser. No. 15/943,168 titled TRANSACTION PROCESS USING BLOCKCHAIN TOKEN SMART CONTRACTS and filed on Apr. 2, 2018, and U.S. application Ser. No. 15/943,271 titled FRAUD MANAGEMENT USING A DISTRIBUTED DATABASE and filed on Apr. 2, 2018, the contents of which are each incorporated by reference in its entirety.

Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors. Various database tuning steps are contemplated to optimize database performance. For example, frequently used files such as indexes may be placed on separate file systems to reduce In/Out (“I/O”) bottlenecks.

More particularly, a “key field” partitions the database according to the high-level class of objects defined by the key field. For example, certain types of data may be designated as a key field in a plurality of related data tables and the data tables may then be linked on the basis of the type of data in the key field. The data corresponding to the key field in each of the linked data tables is preferably the same or of the same type. However, data tables having similar, though not identical, data in the key fields may also be linked by using AGREP, for example. In accordance with one embodiment, any suitable data storage technique may be utilized to store data without a standard format. Data sets may be stored using any suitable technique, including, for example, storing individual files using an ISO/IEC 7816-4 file structure; implementing a domain whereby a dedicated file is selected that exposes one or more elementary files containing one or more data sets; using data sets stored in individual files using a hierarchical filing system; data sets stored as records in a single file (including compression, SQL accessible, hashed via one or more keys, numeric, alphabetical by first tuple, etc.); Binary Large Object (BLOB); stored as ungrouped data elements encoded using ISO/IEC 7816-6 data elements; stored as ungrouped data elements encoded using ISO/IEC Abstract Syntax Notation (ASN.1) as in ISO/IEC 8824 and 8825; and/or other proprietary techniques that may include fractal compression methods, image compression methods, etc.

In various embodiments, the ability to store a wide variety of information in different formats is facilitated by storing the information as a BLOB. Thus, any binary information can be stored in a storage space associated with a data set. As discussed above, the binary information may be stored in association with the system or external to but affiliated with system. The BLOB method may store data sets as ungrouped data elements formatted as a block of binary via a fixed memory offset using either fixed storage allocation, circular queue techniques, or best practices with respect to memory management (e.g., paged memory, least recently used, etc.). By using BLOB methods, the ability to store various data sets that have different formats facilitates the storage of data, in the database or associated with the system, by multiple and unrelated owners of the data sets. For example, a first data set which may be stored may be provided by a first party, a second data set which may be stored may be provided by an unrelated second party, and yet a third data set which may be stored, may be provided by an third party unrelated to the first and second party. Each of these three exemplary data sets may contain different information that is stored using different data storage formats and/or techniques. Further, each data set may contain subsets of data that also may be distinct from other subsets.

As stated above, in various embodiments, the data can be stored without regard to a common format. However, the data set (e.g., BLOB) may be annotated in a standard manner when provided for manipulating the data in the database or system. The annotation may comprise a short header, trailer, or other appropriate indicator related to each data set that is configured to convey information useful in managing the various data sets. For example, the annotation may be called a “condition header”, “header”, “trailer”, or “status”, herein, and may comprise an indication of the status of the data set or may include an identifier correlated to a specific issuer or owner of the data. In one example, the first three bytes of each data set BLOB may be configured or configurable to indicate the status of that particular data set: e.g., LOADED, INITIALIZED, READY, BLOCKED, REMOVABLE, or DELETED. Subsequent bytes of data may be used to indicate for example, the identity of the issuer, user, transaction/membership account identifier or the like. Each of these condition annotations are further discussed herein.

The data set annotation may also be used for other types of status information as well as various other purposes. For example, the data set annotation may include security information establishing access levels. The access levels may, for example, be configured to permit only certain individuals, levels of employees, companies, or other entities to access data sets, or to permit access to specific data sets based on the transaction, merchant, issuer, user or the like. Furthermore, the security information may restrict/permit only certain actions such as accessing, modifying, and/or deleting data sets. In one example, the data set annotation indicates that only the data set owner or the user are permitted to delete a data set, various identified users may be permitted to access the data set for reading, and others are altogether excluded from accessing the data set. However, other access restriction parameters may also be used allowing various entities to access a data set with various permission levels as appropriate.

The data, including the header or trailer may be received by a standalone interaction device configured to add, delete, modify, or augment the data in accordance with the header or trailer. As such, in one embodiment, the header or trailer is not stored on the transaction device along with the associated issuer-owned data but instead the appropriate action may be taken by providing to the user at the standalone device, the appropriate option for the action to be taken. The system may contemplate a data storage arrangement wherein the header or trailer, or header or trailer history, of the data is stored on the system, device, or transaction instrument in relation to the appropriate data.

One skilled in the art will also appreciate that, for security reasons, any databases, systems, devices, servers or other components of the system may consist of any combination thereof at a single location or at multiple locations, wherein each database or system includes any of various suitable security features, such as firewalls, access codes, encryption, decryption, compression, decompression, and/or the like.

Encryption may be performed by way of any of the techniques now available in the art or which may become available—e.g., Twofish, RSA, El Gamal, Schorr signature, DSA, PGP, PM, GPG (GnuPG), HPE Format-Preserving Encryption (FPE), Voltage, and symmetric and asymmetric cryptosystems. The systems and methods may also incorporate SHA series cryptographic methods as well as ECC (Elliptic Curve Cryptography) and other Quantum Readable Cryptography Algorithms under development.

The computing unit of the web client may be further equipped with an Internet browser connected to the Internet or an intranet using standard dial-up, cable, DSL or any other Internet protocol known in the art. Transactions originating at a web client may pass through a firewall in order to prevent unauthorized access from users of other networks. Further, additional firewalls may be deployed between the varying components of CMS to further enhance security.

Firewall may include any hardware and/or software suitably configured to protect CMS components and/or enterprise computing resources from users of other networks. Further, a firewall may be configured to limit or restrict access to various systems and components behind the firewall for web clients connecting through a web server. Firewall may reside in varying configurations including Stateful Inspection, Proxy based, access control lists, and Packet Filtering among others. Firewall may be integrated within a web server or any other CMS components or may further reside as a separate entity. A firewall may implement network address translation (“NAT”) and/or network address port translation (“NAPE”). A firewall may accommodate various tunneling protocols to facilitate secure communications, such as those used in virtual private networking. A firewall may implement a demilitarized zone (“DMZ”) to facilitate communications with a public network such as the Internet. A firewall may be integrated as software within an Internet server, any other application server components or may reside within another computing device or may take the form of a standalone hardware component.

The computers discussed herein may provide a suitable website or other Internet-based graphical user interface which is accessible by users. In one embodiment, the MICROSOFT® INTERNET INFORMATION SERVICES® (IIS), MICROSOFT® Transaction Server (MTS), and MICROSOFT® SQL Server, are used in conjunction with the MICROSOFT® operating system, MICROSOFT® NT web server software, a MICROSOFT® SQL Server database system, and a MICROSOFT® Commerce Server. Additionally, components such as Access or MICROSOFT® SQL Server, ORACLE®, Sybase, Informix MySQL, Interbase, etc., may be used to provide an Active Data Object (ADO) compliant database management system. In one embodiment, the Apache web server is used in conjunction with a Linux operating system, a MySQL database, and the Perl, PHP, Ruby, and/or Python programming languages.

Any of the communications, inputs, storage, databases or displays discussed herein may be facilitated through a website having web pages. The term “web page” as it is used herein is not meant to limit the type of documents and applications that might be used to interact with the user. For example, a typical website might include, in addition to standard HTML documents, various forms, JAVA® applets, JAVASCRIPT®, active server pages (ASP), common gateway interface scripts (CGI), extensible markup language (XML), dynamic HTML, cascading style sheets (CSS), AJAX (Asynchronous JAVASCRIPT® And XML), helper applications, plug-ins, and the like. A server may include a web service that receives a request from a web server, the request including a URL and an IP address (e.g., 10.0.0.2). The web server retrieves the appropriate web pages and sends the data or applications for the web pages to the IP address. Web services are applications that are capable of interacting with other applications over a communications means, such as the internet. Web services are typically based on standards or protocols such as XML, SOAP, AJAX, WSDL and UDDI. Web services methods are well known in the art, and are covered in many standard texts. For example, representational state transfer (REST), or RESTful, web services may provide one way of enabling interoperability between applications.

Middleware may include any hardware and/or software suitably configured to facilitate communications and/or process transactions between disparate computing systems. Middleware components are commercially available and known in the art. Middleware may be implemented through commercially available hardware and/or software, through custom hardware and/or software components, or through a combination thereof. Middleware may reside in a variety of configurations and may exist as a standalone system or may be a software component residing on the Internet server. Middleware may be configured to process transactions between the various components of an application server and any number of internal or external systems for any of the purposes disclosed herein. WEBSPHERE® MQTM (formerly MQSeries) by IBM®, Inc. (Armonk, N.Y.) is an example of a commercially available middleware product. An Enterprise Service Bus (“ESB”) application is another example of middleware.

Practitioners will also appreciate that there are a number of methods for displaying data within a browser-based document. Data may be represented as standard text or within a fixed list, scrollable list, drop-down list, editable text field, fixed text field, pop-up window, and the like. Likewise, there are a number of methods available for modifying data in a web page such as, for example, free text entry using a keyboard, selection of menu items, check boxes, option boxes, and the like.

The system and method may be described herein in terms of functional block components, screen shots, optional selections and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, C#, JAVA®, JAVASCRIPT, JAVASCRIPT Object Notation (JSON), VBScript, Macromedia Cold Fusion, COBOL, MICROSOFT® Active Server Pages, assembly, PERL, PHP, awk, Python, Visual Basic, SQL Stored Procedures, PL/SQL, any UNIX shell script, and extensible markup language (XML) with the various algorithms being implemented with any combination of data structures, objects, processes, routines or other programming elements. Further, it should be noted that the system may employ any number of conventional techniques for data transmission, signaling, data processing, network control, and the like. Still further, the system could be used to detect or prevent security issues with a client-side scripting language, such as JAVASCRIPT, VBScript, or the like. Cryptography and network security methods are well known in the art, and are covered in many standard texts.

In various embodiments, the software elements of the system may also be implemented using Node.js®. Node.js® may implement several modules to handle various core functionalities. For example, a package management module, such as Npm®, may be implemented as an open source library to aid in organizing the installation and management of third-party Node.js® programs. Node.js® may also implement a process manager such as, for example, Parallel Multithreaded Machine (“PM2”); a resource and performance monitoring tool such as, for example, Node Application Metrics (“appmetrics”); a library module for building user interfaces, such as for example ReachJS®; and/or any other suitable and/or desired module.

As will be appreciated by one of ordinary skill in the art, the system may be embodied as a customization of an existing system, an add-on product, a processing apparatus executing upgraded software, a standalone system, a distributed system, a method, a data processing system, a device for data processing, and/or a computer program product. Accordingly, any portion of the system or a module may take the form of a processing apparatus executing code, an internet based embodiment, an entirely hardware embodiment, or an embodiment combining aspects of the internet, software and hardware. Furthermore, the system may take the form of a computer program product on a computer-readable storage medium having computer-readable program code means embodied in the storage medium. Any suitable computer-readable storage medium may be utilized, including hard disks, CD-ROM, BLU-RAY, optical storage devices, magnetic storage devices, and/or the like.

The system and method is described herein with reference to screen shots, block diagrams and flowchart illustrations of methods, apparatus (e.g., systems), and computer program products according to various embodiments. It will be understood that each functional block of the block diagrams and the flowchart illustrations, and combinations of functional blocks in the block diagrams and flowchart illustrations, respectively, can be implemented by computer program instructions.

Referring now to FIG. 3, the process flows and/or screenshots depicted are merely embodiments and are not intended to limit the scope of the disclosure. For example, the steps recited in any of the method or process descriptions may be executed in any order and are not limited to the order presented.

These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user WINDOWS®, webpages, websites, web forms, prompts, etc. Practitioners will appreciate that the illustrated steps described herein may comprise in any number of configurations including the use of WINDOWS®, webpages, web forms, popup WINDOWS®, prompts and the like. It should be further appreciated that the multiple steps as illustrated and described may be combined into single webpages and/or WINDOWS® but have been expanded for the sake of simplicity. In other cases, steps illustrated and described as single process steps may be separated into multiple webpages and/or WINDOWS® but have been combined for simplicity.

The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” and “non-transitory computer-readable storage medium” should be construed to exclude only those types of transitory computer-readable media which were found in In re Nuijten to fall outside the scope of patentable subject matter under 35 U.S.C. § 101.

The disclosure and claims do not describe only a particular outcome of peer-to-peer money transfers, but the disclosure and claims include specific rules for implementing the outcome of peer-to-peer money transfers and that render information into a specific format that is then used and applied to create the desired results of peer-to-peer money transfers, as set forth in McRO, Inc. v. Bandai Namco Games America Inc. (Fed. Cir. case number 15-1080, Sep. 13, 2016). In other words, the outcome of peer-to-peer money transfers can be performed by many different types of rules and combinations of rules, and this disclosure includes various embodiments with specific rules. While the absence of complete preemption may not guarantee that a claim is eligible, the disclosure does not sufficiently preempt the field of peer-to-peer money transfers at all. The disclosure acts to narrow, confine, and otherwise tie down the disclosure so as not to cover the general abstract idea of just peer-to-peer money transfers. Significantly, other systems and methods exist for peer-to-peer money transfers, so it would be inappropriate to assert that the claimed invention preempts the field or monopolizes the basic tools of peer-to-peer money transfers. In other words, the disclosure will not prevent others from peer-to-peer money transfers, because other systems are already performing the functionality in different ways than the claimed invention. Moreover, the claimed invention includes an inventive concept that may be found in the non-conventional and non-generic arrangement of known, conventional pieces, in conformance with Bascom v. AT&T Mobility, 2015-1763 (Fed. Cir. 2016). The disclosure and claims go way beyond any conventionality of any one of the systems in that the interaction and synergy of the systems leads to additional functionality that is not provided by any one of the systems operating independently. The disclosure and claims may also include the interaction between multiple different systems, so the disclosure cannot be considered an implementation of a generic computer, or just “apply it” to an abstract process. The disclosure and claims may also be directed to improvements to software with a specific implementation of a solution to a problem in the software arts.

In various embodiments, the systems and methods may include a graphical user interface for dynamically relocating/rescaling obscured textual information of an underlying window to become automatically viewable to the user (e.g., via sender device 110, receiver device 120, etc.). By permitting textual information to be dynamically relocated based on an overlap condition, the computer's ability to display information is improved. More particularly, the method for dynamically relocating textual information within an underlying window displayed in a graphical user interface may comprise displaying a first window containing textual information in a first format within a graphical user interface on a computer screen; displaying a second window within the graphical user interface; constantly monitoring the boundaries of the first window and the second window to detect an overlap condition where the second window overlaps the first window such that the textual information in the first window is obscured from a user's view; determining the textual information would not be completely viewable if relocated to an unobstructed portion of the first window; calculating a first measure of the area of the first window and a second measure of the area of the unobstructed portion of the first window; calculating a scaling factor which is proportional to the difference between the first measure and the second measure; scaling the textual information based upon the scaling factor; automatically relocating the scaled textual information, by a processor, to the unobscured portion of the first window in a second format during an overlap condition so that the entire scaled textual information is viewable on the computer screen by the user; and automatically returning the relocated scaled textual information, by the processor, to the first format within the first window when the overlap condition no longer exists.

In various embodiments, the system may also include isolating and removing malicious code from electronic messages (e.g., money transfer requests, money transfers, authentication challenges, etc.) to prevent a computer (e.g., sender device 110, receiver device 120, etc.) or network from being compromised, for example by being infected with a computer virus. The system may scan electronic communications for malicious computer code and clean the electronic communication before it may initiate malicious acts. The system operates by physically isolating a received electronic communication in a “quarantine” sector of the computer memory. A quarantine sector is a memory sector created by the computer's operating system such that files stored in that sector are not permitted to act on files outside that sector. When a communication containing malicious code is stored in the quarantine sector, the data contained within the communication is compared to malicious code-indicative patterns stored within a signature database. The presence of a particular malicious code-indicative pattern indicates the nature of the malicious code. The signature database further includes code markers that represent the beginning and end points of the malicious code. The malicious code is then extracted from malicious code-containing communication. An extraction routine is run by a file parsing component of the processing unit. The file parsing routine performs the following operations: scan the communication for the identified beginning malicious code marker; flag each scanned byte between the beginning marker and the successive end malicious code marker; continue scanning until no further beginning malicious code marker is found; and create a new data file by sequentially copying all non-flagged data bytes into the new file, which forms a sanitized communication file. The new, sanitized communication is transferred to a non-quarantine sector of the computer memory. Subsequently, all data on the quarantine sector is erased. More particularly, the system includes a method for protecting a computer from an electronic communication containing malicious code by receiving an electronic communication containing malicious code in a computer with a memory having a boot sector, a quarantine sector and a non-quarantine sector; storing the communication in the quarantine sector of the memory of the computer, wherein the quarantine sector is isolated from the boot and the non-quarantine sector in the computer memory, where code in the quarantine sector is prevented from performing write actions on other memory sectors; extracting, via file parsing, the malicious code from the electronic communication to create a sanitized electronic communication, wherein the extracting comprises scanning the communication for an identified beginning malicious code marker, flagging each scanned byte between the beginning marker and a successive end malicious code marker, continuing scanning until no further beginning malicious code marker is found, and creating a new data file by sequentially copying all non-flagged data bytes into a new file that forms a sanitized communication file; transferring the sanitized electronic communication to the non-quarantine sector of the memory; and deleting all data remaining in the quarantine sector.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to ‘at least one of A, B, and C’ or ‘at least one of A, B, or C’ is used in the claims or specification, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Although the disclosure includes a method, it is contemplated that it may be embodied as computer program instructions on a tangible computer-readable carrier, such as a magnetic or optical memory or a magnetic or optical disk. All structural, chemical, and functional equivalents to the elements of the above-described various embodiments that are known to those of ordinary skill in the art are expressly incorporated herein by reference and are intended to be encompassed by the present claims.

Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims. No claim element is intended to invoke 35 U.S.C. 112(f) unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A method, comprising:
receiving, by a payment network, a money transfer request comprising a receiver, a money transfer amount, and a sender transaction account;
deducting, by the payment network, the money transfer amount from the sender transaction account;
generating, by the payment network, a receiver transaction account associated with the receiver, wherein the receiver transaction account comprises the money transfer amount; and
providing, by the payment network, the receiver access to the receiver transaction account, wherein the receiver transaction account is provided to the receiver as a digital transaction instrument or a physical transaction instrument.

2. The method of claim 1, further comprising authorizing, by the payment network, the money transfer request by validating that the sender transaction account is capable of transferring the money transfer amount.

3. The method of claim 1, further comprising:
transmitting, by the payment network, an authentication challenge to a receiver device associated with the receiver; and
validating, by the payment network, an authentication response by comparing the authentication response to the authentication challenge, wherein in response to validating the authentication response the payment network is configured to generate the receiver transaction account.

4. The method of claim 1, further comprising transmitting, by the payment network, a receiver data request to the receiver device associated with the receiver, wherein the receiver data request comprises data prompting the receiver to input at least one of a receiver name, a receiver email address, a receiver phone number, a receiver social security number (SSN), or a driver's license number.

5. The method of claim 4, further comprising:
receiving, by the payment network, a receiver data response based on the receiver data request; and
authenticating, by the payment network, the receiver data response by validating the receiver data response using at least one of an internal data source or an external data source.

6. The method of claim 1, wherein the money transfer request comprises at least one of a transfer channel, a personalized message, or a transfer date.

7. The method of claim 6, wherein the receiver transaction account is provided to the receiver via the transfer channel.

8. A system comprising:
a processor,
a tangible, non-transitory memory configured to communicate with the processor,
the tangible, non-transitory memory having instructions stored thereon that, in response to execution by the processor, cause the processor to perform operations comprising:
receiving, by the processor, a money transfer request comprising a receiver, a money transfer amount, and a sender transaction account;
deducting, by the processor, the money transfer amount from the sender transaction account;
generating, by the processor, a receiver transaction account associated with the receiver, wherein the receiver transaction account comprises the money transfer amount; and
providing, by the processor, the receiver access to the receiver transaction account, wherein the receiver transaction account is provided to the receiver as a digital transaction instrument or a physical transaction instrument.

9. The system of claim 8, further comprising authorizing, by the processor, the money transfer request by validating that the sender transaction account is capable of transferring the money transfer amount.

10. The system of claim 8, further comprising:
transmitting, by the processor, an authentication challenge to a receiver device associated with the receiver; and
validating, by the processor, an authentication response by comparing the authentication response to the authentication challenge, wherein in response to validating the authentication response the processor is configured to generate the receiver transaction account.

11. The system of claim 8, further comprising transmitting, by the processor, a receiver data request to the receiver device associated with the receiver, wherein the receiver data request comprises data prompting the receiver to input at least one of a receiver name, a receiver email address, a receiver phone number, a receiver social security number (SSN), or a driver's license number.

12. The system of claim 11, further comprising:
receiving, by the processor, a receiver data response based on the receiver data request; and
authenticating, by the processor, the receiver data response by validating the receiver data response using at least one of an internal data source or an external data source.

13. The system of claim 8, wherein the money transfer request comprises at least one of a transfer channel, a personalized message, or a transfer date.

14. The system of claim 13, wherein the receiver transaction account is provided to the receiver via the transfer channel.

15. An article of manufacture including a non-transitory, tangible computer readable storage medium having instructions stored thereon that, in response to execution by a computer based system, cause the computer based system to perform operations comprising:
receiving, by the computer based system, a money transfer request comprising a receiver, a money transfer amount, and a sender transaction account;
deducting, by the computer based system, the money transfer amount from the sender transaction account;
generating, by the computer based system, a receiver transaction account associated with the receiver, wherein the receiver transaction account comprises the money transfer amount; and
providing, by the computer based system, the receiver access to the receiver transaction account, wherein the receiver transaction account is provided to the receiver as a digital transaction instrument or a physical transaction instrument.

16. The article of manufacture of claim 15, further comprising authorizing, by the computer based system, the money transfer request by validating that the sender transaction account is capable of transferring the money transfer amount.

17. The article of manufacture of claim 15, further comprising:
transmitting, by the computer based system, an authentication challenge to a receiver device associated with the receiver; and
validating, by the computer based system, an authentication response by comparing the authentication response to the authentication challenge, wherein in response to validating the authentication response the computer based system is configured to generate the receiver transaction account.

18. The article of manufacture of claim 15, further comprising transmitting, by the computer based system, a receiver data request to the receiver device associated with the receiver, wherein the receiver data request comprises data prompting the receiver to input at least one of a receiver name, a receiver email address, a receiver phone number, a receiver social security number (SSN), or a driver's license number.

19. The article of manufacture of claim 18, further comprising:
receiving, by the computer based system, a receiver data response based on the receiver data request; and
authenticating, by the computer based system, the receiver data response by validating the receiver data response using at least one of an internal data source or an external data source.

20. The article of manufacture of claim 15, wherein the money transfer request comprises at least one of a transfer channel, a personalized message, or a transfer date, and wherein the receiver transaction account is provided to the receiver via the transfer channel.
